(19) United States
(12) Patent Application Publication
(10) Pub. No.: US 2025/0225902 A1
(43) Pub. Date: Jul. 10, 2025

(54) ELECTRONIC DEVICE AND METHOD FOR SCHEDULING DISPLAY OF IMAGE ON BASIS OF SIGNAL FROM TOUCH CIRCUIT

(71) Applicant: Samsung Electronics Co., Ltd., Suwon-si (KR)

(72) Inventors: Jaesung LEE, Suwon-si (KR); Kyounghwan KWON, Suwon-si (KR); Jongkon BAE, Suwon-si (KR); Donghwy KIM, Suwon-si (KR); Byungduk YANG, Suwon-si (KR)

(21) Appl. No.: 19/090,139

(22) Filed: Mar. 25, 2025

(30) Foreign Application Priority Data
Sep. 30, 2022 (KR) 10-2022-0125365
Jan. 4, 2023 (KR) 10-2023-0001471
Feb. 21, 2023 (KR) 10-2023-0023212
Mar. 20, 2023 (KR) 10-2023-0036078
Sep. 25, 2023 (WO) PCT/KR2023/014711

(51) Int. Cl. G09G 3/20; G06F 3/041

(52) U.S. Cl. CPC G09G 3/20; G06F 3/0412; G06F 3/0416; G09G 2320/0247; G09G 2320/0252; G09G 2320/0257; G09G 2340/0435; G09G 2354/00

(57) ABSTRACT

An example electronic device may include at least one processor; a touch circuit; a display panel; a display driver circuit including memory; a first path connecting the touch circuit and the processor; and a second path connecting the touch circuit and the display drive circuit. The display driver circuit may be configured to display an image on the display panel based on a refresh rate that is lower than a reference refresh rate; receive a signal, transmitted to the processor through the first path and indicating contact on the image displayed on the display panel, from the touch circuit through the second path; and refrain from executing, in response to the signal, redisplay of the image, which is executed by scanning the image stored in the memory on the basis of the refresh rate, within a reference time interval from the reception timing of the signal.

### CROSS-REFERENCE TO RELATED APPLICATIONS

This application is a continuation of International Application No. PCT/KR2023/014941, designating the United States, filed on Sep. 26, 2023, in the Korean Intellectual Property Receiving Office and claiming priority to Korean Patent Application Nos. 10-2022-0125365, filed on Sep. 30, 2022; 10-2023-0001471, filed on Jan. 4, 2023; 10-2023-0023212, filed on Feb. 21, 2023; and 10-2023-0036078, filed on Mar. 20, 2023, in the Korean Intellectual Property Office and to PCT International Application No. PCT/KR2023/014711 filed on Sep. 25, 2023, in the Korean Intellectual Property Receiving Office, the disclosures of each of which are incorporated by reference herein in their entireties.

### BACKGROUND

### Field

The disclosure relates to an electronic device and a method for scheduling display of an image based on a signal from touch circuitry.

### Description of Related Art

An electronic device may include a display panel. For example, the electronic device may include display driver circuitry operably coupled to the display panel. For example, the display driver circuitry may display an image obtained from a processor of the electronic device on the display panel.

The above-described information may be provided as a related art for the purpose of helping to understand the present disclosure. No claim or determination is raised as to whether any of the above-described information may be applied as a prior art related to the present disclosure.

### SUMMARY

In an example embodiment, an electronic device may include at least one processor (including, e.g., processing circuitry); touch circuitry; a display panel; and display driver circuitry including memory. A first path (e.g., an electrical path) may connect the processor to the touch circuitry and a second path (e.g., an electrical path) may connect the display driver circuitry to the touch circuitry. The display driver circuitry may be configured to, based on a refresh rate lower than a reference refresh rate, display, via the display panel, an image; receive, through the second path, from the touch circuitry, a signal transmitted through the first path to the processor, the signal indicating a contact on the image displayed on the display panel; and in response to the signal, refrain from, within a reference time interval from a reception timing of the signal, a re-displaying of the image executed by scanning the image stored in the memory based on the refresh rate.

In an example embodiment, a method may be executed in an electronic device including at least one processor, touch circuitry, a display panel, display driver circuitry including memory, a first path connecting the processor to the touch circuitry, and a second path connecting the display driver circuitry to the touch circuitry. The method may include, based on a refresh rate lower than a reference refresh rate, displaying, by the display driver circuitry, via the display panel, an image; receiving, by the display driver circuitry, through the second path, from the touch circuitry, a signal transmitted through the first path to the processor, the signal indicating a contact on the image displayed on the display panel; and, in response to the signal, refraining from, by the display driver circuitry, within a reference time interval from a reception timing of the signal, a re-displaying of the image executed by scanning the image stored in the memory based on the refresh rate.

In an example embodiment, an electronic device may include at least one processor (including, e.g., processing circuitry); touch circuitry; a display panel; and display driver circuitry including memory. A first path may connect the processor to the touch circuitry and a second path may connect the display driver circuitry to the touch circuitry. The display driver circuitry may be configured to, based on a refresh rate lower than a reference refresh rate, display, via the display panel, an image; receive, through the second path, from the touch circuitry, a signal transmitted through the first path to the processor, the signal indicating a contact on the image displayed on the display panel; in response to the signal, identify a start timing of re-displaying of the image to be executed by scanning the image stored in the memory based on the refresh rate execute the re-displaying from the start timing, based on the start timing being within a reference time interval from a reception timing of the signal; and refrain from executing the re-displaying, based on the start timing being out of the reference time interval.

In an example embodiment, a method executed in an electronic device including a processor, touch circuitry, a display panel, display driver circuitry including memory, a first path connecting the processor to the touch circuitry, and a second path connecting the display driver circuitry to the touch circuitry, may include, based on a refresh rate lower than a reference refresh rate, displaying, by the display driver circuitry, via the display panel, an image; receiving, by the display driver circuitry, through the second path, from the touch circuitry, a signal transmitted through the first path to the processor, the signal indicating a contact on the image displayed on the display panel; in response to the signal, identifying, by the display driver circuitry, a start timing of re-displaying of the image to be executed by scanning the image stored in the memory based on the refresh rate; executing, by the display driver circuitry, the re-displaying from the start timing, based on the start timing being within a reference time interval from a reception timing of the signal; and refraining from, by the display driver circuitry, executing the re-displaying, based on the start timing being out of the reference time interval.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a simplified block diagram illustrating an example electronic device according to various embodiments;

FIG. 2 illustrates an example method of scheduling a re-displaying of an image, based on a signal from touch circuitry, according to various embodiments;

FIG. 3 illustrates an example of refraining from a re-displaying of an image based on a signal from touch circuitry according to various embodiments;

FIG. 4 illustrates an example of changing a state of another signal provided to a processor from display driver circuitry based on a signal from touch circuitry according to various embodiments;

FIG. 5 illustrates an example method of cancelling to execute a re-displaying, in response to a reception of another image according to various embodiments;

FIG. 6 illustrates an example method of cancelling to execute a re-displaying, based on another signal from touch circuitry according to various embodiments;

FIG. 7 illustrates an example method of identifying whether to execute a re-displaying of an image, based on a signal from touch circuitry, according to various embodiments;

FIG. 8 is a block diagram of an example electronic device in a network environment according to various embodiments; and

FIG. 9 is a block diagram of an example display module according to various embodiments.

### DETAILED DESCRIPTION

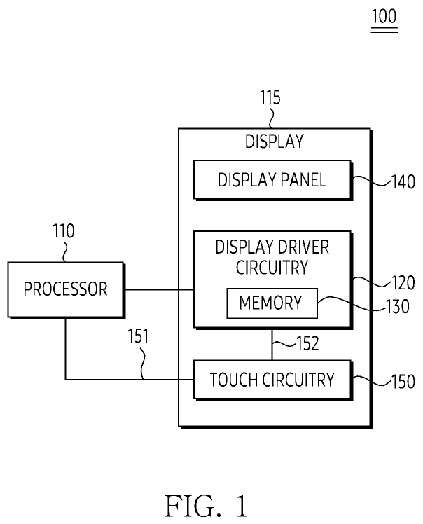

FIG. 1 is a simplified block diagram illustrating an example electronic device according to various embodiments.

Referring to FIG. 1, an electronic device 100 may include at least one processor 110 and a display 115.

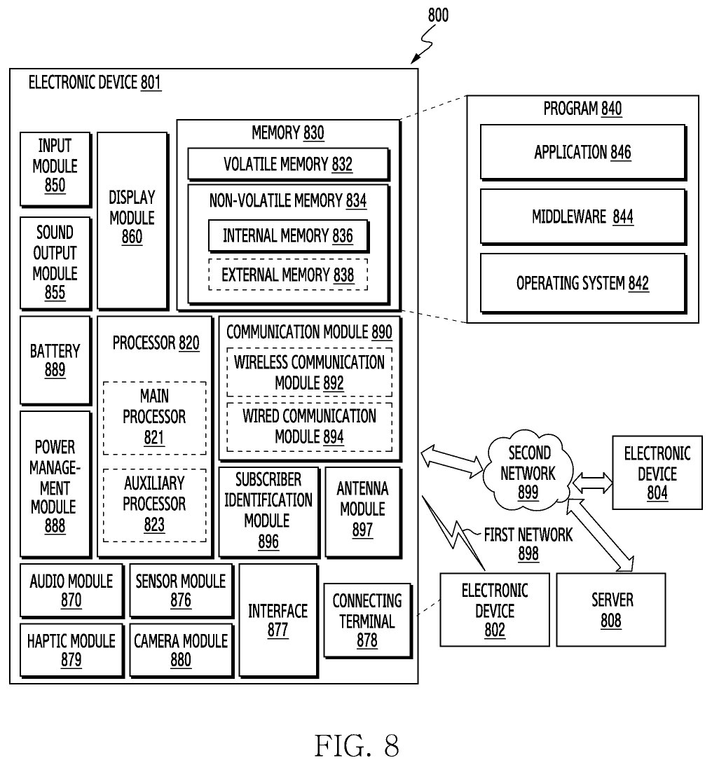

The processor 110 (including, e.g., processing circuitry) may include at least a portion of a processor 820 of FIG. 8. The processor 110 may be operably coupled with display driver circuitry 120 (or the display 115). The processor 110 being “operably coupled” with the display driver circuitry 120 may refer, for example, to the processor 110 being directly or indirectly connected to the display driver circuitry 120. For example, the processor 110 being operably coupled with the display driver circuitry 120 may refer to the processor 110 being connected to the display driver circuitry 120 through at least one interface. As a non-limiting example, the at least one interface may include a first interface that connects the processor 110 and the display driver circuitry 120 and is used for a transmission (e.g., image transmission) from the processor 110 to the display driver circuitry 120. For example, the at least one interface may include a second interface that connects the processor 110 and the display driver circuitry 120 and is used for a transmission from the display driver circuitry 120 to the processor 110. The second interface may be separate from the first interface. For example, an indication signal (e.g., a refresh window (RW) signal or RW) provided to the processor 110 from the display driver circuitry 120 through the second interface may be used to request the image transmission. For example, the indication signal may be used to indicate whether the image transmission is enabled or disabled.

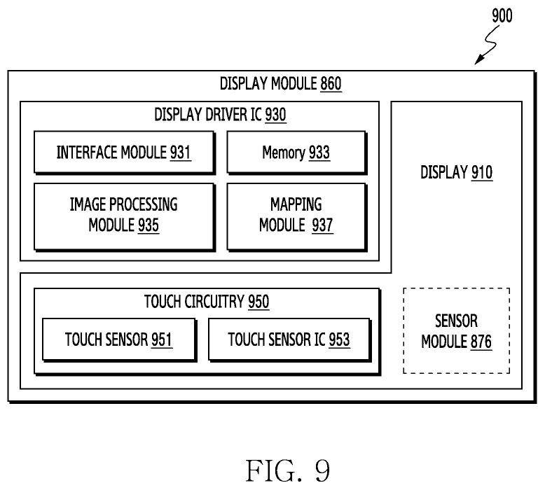

The display 115 may include at least a portion of a display module 860 of FIGS. 8 and 9. The display 115 may include display driver circuitry 120, a display panel 140, and touch circuitry 150.

The display driver circuitry 120 may include at least a portion of a DDI 930 of FIG. 9. The display driver circuitry 120 may include memory 130. The memory 130 may include at least a portion of memory 933 of FIG. 9. The memory 130 may be referred to, for example, as a graphic random access memory (GRAM) or a frame buffer memory.

The display panel 140 may include at least a portion of a display 910 of FIG. 9.

The touch circuitry 150 may include at least a portion of touch circuitry 950 of FIG. 9.

For example, the display driver circuitry 120 may receive an image to be displayed on the display panel 140 from the processor 110. For example, the image may be received based on an image transmission from the processor 110 to the display driver circuitry 120, which is executed at a timing identified by the processor 110 from among the processor 110 and the display driver circuitry 120.

For example, the display driver circuitry 120 may display the image on the display panel 140. For example, the display driver circuitry 120 may store the image in the memory 130. For example, the display driver circuitry 120 may store the image in the memory 130 while displaying the image on the display panel 140 in response to the reception. For example, storing the image may be executed to re-display the image. For example, the re-displaying of the image may be executed to maintain the image on the display panel 140 while the processor 110 is in a sleep state (and/or a low power state). For example, the re-displaying of the image may be executed to reduce the occurrence of afterimage on the display panel 140. For example, the re-displaying of the image may be executed to reduce the occurrence of blinking on the display panel 140. However, the disclosure is not limited in this respect.

For example, the display driver circuitry 120 may store the image in the memory 130, based at least in part on a refresh rate for the image, which is lower than a reference refresh rate. For example, the display driver circuitry 120 may store the image in the memory 130, based at least in part on a change from the refresh rate lower than the reference refresh rate to another refresh rate higher than or equal to the reference refresh rate. For example, the display driver circuitry 120 may store the image in the memory 130, based on a control command, which is received from the processor 110 and indicates enabling the memory 130. As a non-limiting example, the control command may be applied only to operations of the display driver circuitry 120 for the image. However, the disclosure is not limited in this respect. As a non-limiting example, the control command may be referred to as still indication. For example, the still indication may include sticky flag indication and/or on-the-fly indication.

For example, the display driver circuitry 120 may display the image again on the display panel 140, by scanning the image in the memory 130. For example, the display driver circuitry 120 may display the image again, based on the scanning of the image in the memory 130 to maintain the image on the display panel 140 while the processor 110 is in the sleep state (or the low power state). For example, the display driver circuitry 120 may display the image again based on the scanning of the image in the memory 130 to reduce the occurrence of the afterimage on the display panel 140. For example, the display driver circuitry 120 may display the image again based on the scanning of the image in the memory 130 to reduce the occurrence of the blinking on the display panel 140. However, the disclosure is not limited in this respect.

For example, while the image is displayed (or re-displayed) on the display panel 140, a contact on the image may occur. For example, the contact may be identified through the touch circuitry 150. For example, the contact may occur on the image for a touch input. For example, the processor 110 may obtain or generate a response (or feedback) corresponding to the contact, based on signals obtained through a first path 151 (e.g., electrical or signal path) connecting the touch circuitry 150 (or the display driver circuitry 120 (e.g., touch display driver IC (TDDI)) and the processor 110. For example, the signals may include a signal (e.g., touch screen panel (TSP)_interrupt) indicating the contact. For example, the signals may include data (coordinate data related to the contact) indicating an area on the image (or an area on the display panel 140) where the contact is located. For example, the signal may be transmitted from the touch circuitry 150 to the processor 110 through the first path 151, before the data (coordinate data related to the contact) is transmitted from the touch circuitry 150 to the processor 110 through the first path 151.

For example, the processor 110 may obtain another image as a response (or feedback) to the contact, based on the signals and the image. The other image may be at least partially different from the image. For example, the other image may include at least one content corresponding to the response (or the feedback). For example, the processor 110 may transmit the other image to the display driver circuitry 120. For example, the display driver circuitry 120 may display the other image received from the processor 110 as an image changed from the image on the display panel 140.

For example, in a case that the re-displaying of the image is scheduled before the contact occurs on the display panel 140, the processor 110 may defer transmitting the other image to the display driver circuitry 120 while the re-displaying of the image is being executed.

For example, the deferring may be executed based on a state of the indication signal provided from the display driver circuitry 120 to the processor 110. For example, the display driver circuitry 120 may change a state of the indication signal provided from the display driver circuitry 120 to the processor 110 from a first state indicating that an image transmission from the processor 110 to the display driver circuitry 120 is enabled to a second state indicating that the image transmission is disabled, before scanning the image in the memory 130 for the re-displaying of the image. The processor 110 may defer transmitting the other image to the display driver circuitry 120 in response to obtaining the other image, based on the indication signal in the second state. For example, the display driver circuitry 120 may change the state of the indication signal from the second state to the first state, in response to a completion of the scanning of the image in the memory 130 for the re-displaying of the image. For example, the processor 110 may transmit the other image for which the image transmission has been deferred to the display driver circuitry 120, based on the indication signal in the first state. For example, the display driver circuitry 120 may display the other image received from the processor 110 on the display panel 140.

For example, the deferring may be executed based on a timing for the image transmission. For example, the timing may correspond to a start timing of a vertical synchronization signal. For example, the image transmission may be executed based on the start timing of the vertical synchronization signal from among a start timing of a light-emitting synchronization signal indicating a light-emitting interval and the start timing of the vertical synchronization signal having a period longer than a period of the light-emitting synchronization signal, within a time interval in which the re-displaying of the image may be executed, and the image transmission may be executed based on the start timing of the light-emitting synchronization signal from among the start timing of the light-emitting synchronization signal and the start timing of the vertical synchronization signal, within a time interval in which the re-displaying of the image is not executed. For example, the processor 110 may transmit the other image to the display driver circuitry 120 at the start timing of the vertical synchronization signal after the scanning of the image is completed, based on identifying that the scanning of the image in the memory 130 for the re-displaying of the image may be executed. For example, the display driver circuitry 120 may display the other image received from the processor 110 on the display panel 140.

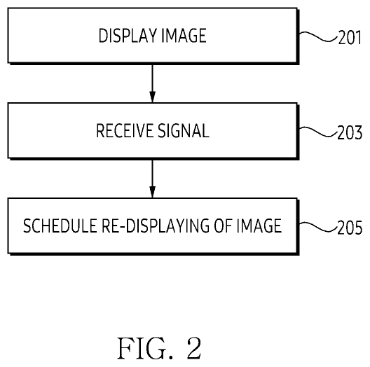

For example, the contact may be a touch input intended by a user. For example, displaying the other image after displaying the image again may be perceived by the user as a delay in the response of the display 115 (or the electronic device 100) to the touch input. For example, since the re-displaying of the image may be transparent to the user, the user may perceive the other image displayed after the image is displayed again, as a delayed response of the display 115 (or electronic device 100). For example, the electronic device 100 may reduce the delay in the response for quality of a service provided to the user through the display 115. For example, the electronic device 100 may include a second path 152 (e.g., electrical or signal path) connecting the touch circuitry 150 to the display driver circuitry 120, to reduce the delay in the response. For example, the second path 152 may be used to provide from the touch circuitry 150 to the processor 110, the signal provided from the touch circuitry 150 to the display driver circuitry 120, the signal indicating the contact. For example, the second path 152 may be used to provide the signal (e.g., TSP_interrupt) from among the signal indicating the contact and the data indicating the area on the image where the contact is located from the touch circuitry 150 to the display driver circuitry 120. For example, the display driver circuitry 120 may schedule the re-displaying of the image based on the signal provided to the display driver circuitry 120 from the touch circuitry 150 through the second path 152. The scheduling will be discussed by way of example with reference to FIG. 2.

FIG. 2 illustrates an example method of scheduling a re-displaying of an image, based on a signal from touch circuitry according to various embodiments.

Referring to FIG. 2, in operation 201, display driver circuitry 120 may display an image on a display panel 140, based on a refresh rate lower than a reference refresh rate. For example, a scanning for displaying the image may include scanning the image received from a processor 110 based on bypassing memory 130 (e.g., a first scan executed while storing the image received from the processor 110) and scanning the image in the memory 130 (e.g., a second scan executed after the first scan). For example, the display of the image may include displaying the image by scanning the image received from the processor 110. For example, the display of the image may include re-displaying the image by scanning the image in the memory 130.

For example, when displaying the image in operation 201 is executed in accordance with the first scan, the display driver circuitry 120 may store the image in the memory 130 while executing operation 201. For example, the display driver circuitry 120 may store the image in the memory 130 based on a control command obtained from the processor 110 based on the refresh rate lower than the reference refresh rate before the image is received from the processor 110, the control command indicating enabling the memory 130. As a non-limiting example, the control command may be referred to as still indication. For example, the still indication may include a sticky flag indication and/or an on-the-fly indication.

For example, when displaying the image in operation 201 is executed in accordance with the second scan, the display driver circuitry 120 may store the image in the memory 130 while executing the first scan before executing operation 201. For example, the display driver circuitry 120 may store the image in the memory 130, based on a control command obtained from the processor 110 based on the refresh rate lower than the reference refresh rate before the image is received from the processor 110, the control command indicating enabling the memory 130.

For example, the memory 130 may be disabled based at least in part on another refresh rate higher than or equal to the reference refresh rate and enabled based on the refresh rate lower than the reference refresh rate. For example, the memory 130 may be enabled within a time interval for the other refresh rate, in response to a change from the refresh rate to the other refresh rate.

In operation 203, the display driver circuitry 120 may receive, from the touch circuitry 150 through the second path 152, a signal transmitted to the processor 110 through the first path 151, the signal indicating a contact on the image displayed on the display panel 140. For example, the signal may indicate that the contact occurs.

In operation 205, the display driver circuitry 120 may schedule the re-displaying of the image in response to the signal. For example, the display driver circuitry 120 may refrain from, in response to the signal, executing the re-displaying of the image executed by scanning the image stored in the memory 130 based on the refresh rate, within a reference time interval from a reception timing of the signal.

For example, the reference time interval may be determined or defined based on a time at which operations of the touch circuitry 150 related to the contact are executed and a time at which operations of the processor 110 related to the contact are executed. For example, the processor 110 may receive, in response to the contact, the signal (e.g., the signal transmitted from the touch circuitry 150 to the processor 110 in operation 203) from the touch circuitry 150 through the first path 151. The processor 110 may receive data transmitted from the touch circuitry 150 through the first path 151 after the signal is transmitted, the data indicating an area on which the contact is located. The processor 110 may obtain the other image corresponding to the contact based on the signal and the data. For example, the processor 110 may transmit the other image to the display driver circuitry 120. For example, the reference time interval may be determined, defined, or identified based on the time consumed to transmit the signal and the data from the touch circuitry 150 to the processor 110 and/or the time consumed to obtain the other image based on the signal and the data.

For example, refraining from executing the re-displaying of the image may include deferring a start timing of the re-displaying being out of the reference time interval. For example, the refraining from executing the re-displaying of the image may include cancelling the re-displaying.

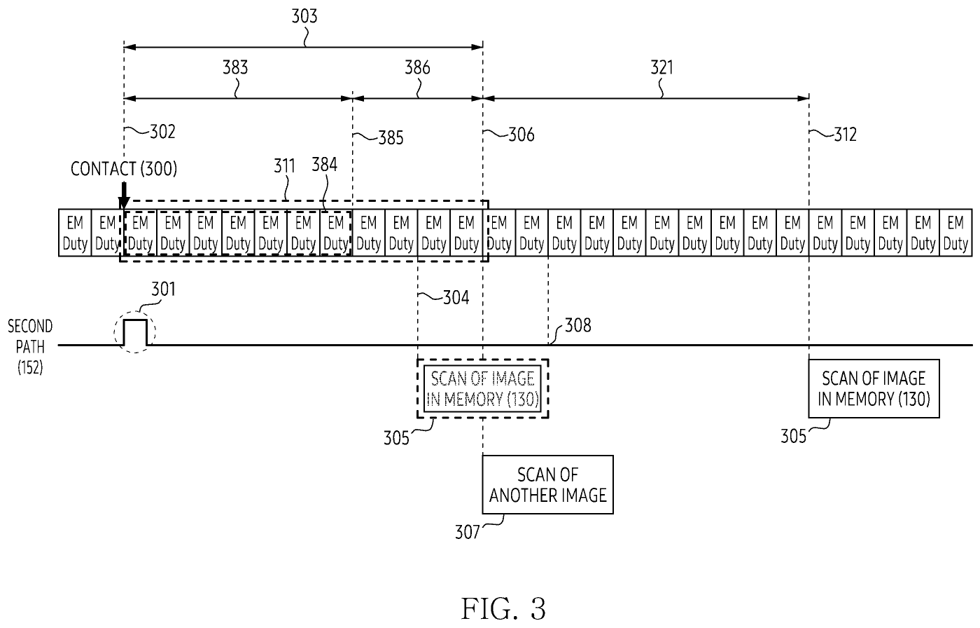

For example, operations of the display driver circuitry 120 executed in response to the signal will be discussed below with reference to FIG. 3.

FIG. 3 illustrates an example of refraining from a re-displaying of an image based on a signal from touch circuitry according to various embodiments.

Referring to FIG. 3, the touch circuitry 150 may, in response to detection (or identification) of a contact 300, transmit a signal 301 indicating the contact 300 to display driver circuitry 120 through a second path 152. Although not illustrated in FIG. 3, touch circuitry 150 may transmit the signal 301 to the processor 110 through a first path 151 and transmit the signal 301 to the display driver circuitry 120 through the second path 152.

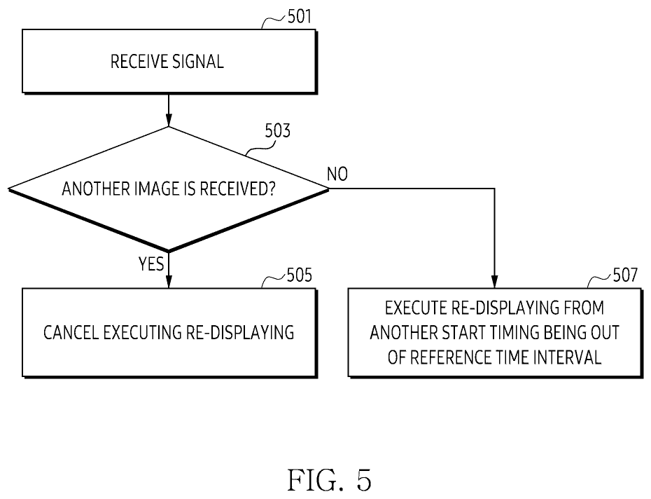

The display driver circuitry 120 may refrain from, in response to the signal 301, executing the re-displaying of the image within a reference time interval 303 from a reception timing 302 of the signal 301. For example, the display driver circuitry 120 may refrain from executing a scan from a start timing of each of light-emitting intervals 311 included within the reference time interval 303 for display on the display panel 140. For example, since a timing 304 is within the reference time interval 303, the display driver circuitry 120 may refrain from executing a scan 305 of the image in the memory 130 for the re-displaying of the image, scheduled from the timing 304. For example, the display driver circuitry 120 may cancel the scan 305 or defer the scan 305. Cancelling or deferring the scan 305 will be discussed below with references to FIG. 5.

For example, since the display driver circuitry 120 refrains from executing the scan 305 within the reference time interval 303, the display driver circuitry 120 may execute a scan 307 of the other image (e.g., response to the contact 300) received from the processor 110 from a timing 306. For example, in order to reduce a delay in the response caused by executing the scan 307 after executing the scan 305, the display driver circuitry 120 may refrain from executing the scan 305 and execute the scan 307. For example, when executing the scan 307 after executing the scan 305, the scan 307 is executed from a timing (e.g., a timing 308) after terminating (or completing) the scan 305, and the time between a timing (e.g., the reception timing 302) of the contact 300 and the timing (e.g., the timing 308) may be perceived by a user as a delay in response, so the display driver circuitry 120 may refrain from executing the scan 305 and execute the scan 307.

FIG. 3 illustrates an example in which the timing 306 is located at an end timing of the reference time interval 303, but the timing 306 may be located at a timing before the end timing of the reference time interval 303. For example, the timing 306 may be within the reference time interval 303. However, the disclosure is not limited in this respect.

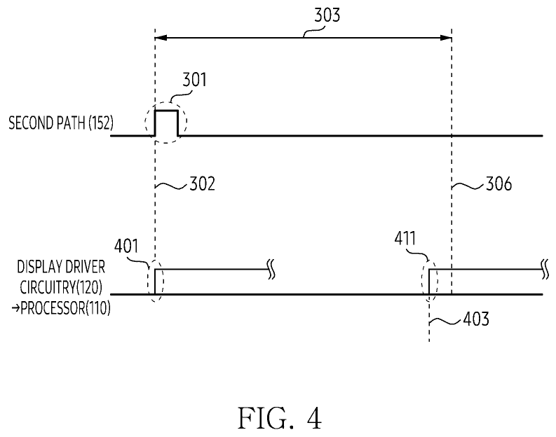

Meanwhile, in order to receive the other image within the reference time interval 303, the display driver circuitry 120 may notify the processor 110 that it is capable of receiving the other image (or enabling an image transmission). For example, in order to indicate that it is capable of receiving the other image, the display driver circuitry 120 may change a state of the indication signal from the second state to the first state, in response to the signal 301 (or based on the signal 301). The change from the second state to the first state will be discussed with reference to FIG. 4.

FIG. 4 illustrates an example of changing a state of another signal provided to a processor from display driver circuitry based on a signal from touch circuitry according to various embodiments.

Referring to FIG. 4, the display driver circuitry 120 may change the state of the indication signal provided from the display driver circuitry 120 to the processor 110 from the second state to the first state, in response to a signal 301, such as a state 401. For example, the display driver circuitry 120 may change the state from the second state to the first state, based on a reception timing 302 of the signal 301. Although not illustrated explicitly in FIG. 4, the display driver circuitry 120 may maintain the state of the indication signal in the first state within a reference time interval 303.

For example, the display driver circuitry 120 may execute a scan for display (e.g., the display of the image) on the display panel 140 when receiving the signal 301. For example, when the signal 301 is received while executing the scan, the display driver circuitry 120 may change the state of the indication signal from the second state to the first state within the reference time interval 303, in response to completion of the scan. For example, the display driver circuitry 120 may change the state of the indication signal to the first state, in response to completion of the scan at a timing 403 within the reference time interval 303, such as a state 411.

FIG. 4 illustrates an example in which the state of the indication signal is changed from the second state to the first state, but this is for convenience of explanation. In a case that there is no scan executed by the display driver circuitry 120 within the reference time interval 303, the display driver circuitry 120 may maintain the state of the indication signal in the first state within the reference time interval 303, based on a reception of the signal 301.

As described above, the electronic device 100 may enhance the responsiveness of touch input by refraining from the re-displaying of the image within the reference time interval 303 based on the signal received by the display driver circuitry 120 through a second path 152.

Referring back to FIG. 1, the display driver circuitry 120 may refrain from the re-displaying of the image within the reference time interval, by cancelling the re-displaying or deferring the re-displaying. Cancelling the re-displaying and deferring the re-displaying will be discussed below with reference to FIG. 5.

FIG. 5 illustrates an example method of cancelling to execute a re-displaying, in response to a reception of another image according to various embodiments.

Operation 501 of FIG. 5 may be related to operation 203 of FIG. 2, and operations 503 to 507 of FIG. 5 may be included within operation 205 of FIG. 2.

Referring to FIG. 5, in operation 501, the display driver circuitry 120 may receive the signal from the touch circuitry 150 through the second path 151 while the image is displayed or maintained on the display panel 140. Operation 501 may at least partially correspond to operation 203 of FIG. 2.

In operation 503, the display driver circuitry 120 may identify whether the other image obtained in accordance with the contact is received from the processor 110 within the reference time interval in response to the signal. For example, the contact may be a touch input intended by the user, but the contact may not be intended by the user. For example, since the signal only indicates the occurrence of the contact and does not indicate whether the contact is a touch input, the display driver circuitry 120 may identify whether the other image is received from the processor 110 within the reference time interval, in order to identify whether the contact is the touch input. For example, the other image being received within the reference time interval may indicate that the contact is the touch input. For example, the other image not being received within the reference time interval may indicate that the contact is not the touch input.

For example, the display driver circuitry 120 may execute operation 505 in response to the other image being received within the reference time interval and execute operation 507 in response to the other image not being received within the reference time interval.

In operation 505, on a condition that the other image is received within the reference time interval, the display driver circuitry 120 may display the other image on the display panel 140 and cancel executing the re-displaying (the re-displaying of the image). Cancelling of executing the re-displaying may indicate discarding the image stored in the memory 130. For example, since displaying the other image on the display panel 140 indicates that at least another display may be executed after the display of the other image, the display driver circuitry 120 may cancel executing the re-displaying.

For example, referring to FIG. 3, the display driver circuitry 120 may remove a scan 305 from scheduling information, and discard the image in the memory 130 based on the removal.

Referring back to FIG. 5, the display driver circuitry 120 may execute the re-displaying from another start timing being out of the reference time interval, on a condition that the other image is not received within the reference time interval. For example, since the other image not being received within the reference time interval indicates that the contact that caused the signal received in operation 501 is not the touch input, the display driver circuitry 120 may execute the re-displaying that was scheduled but not executed within the reference time interval. For example, referring to FIG. 3, the display driver circuitry 120 may execute the re-displaying of the image by executing a scan 305 of the image in the memory 130 from a timing 312, based on identifying that the other image is not received within the reference time interval 303. For example, the display driver circuitry 120 may execute the re-displaying of the image after a predetermined time 321 has elapsed from a timing 306, which is an end timing of the reference time interval 303. For example, the predetermined time 321 may be defined, configured, or set for the other image that was obtained from the processor 110 but whose reception was delayed. However, the disclosure is not limited in this respect.

As described above, the electronic device 100 may refrain from the re-displaying by cancelling or deferring the re-displaying. The electronic device 100 may enhance the responsiveness of touch input by refraining from the re-displaying.

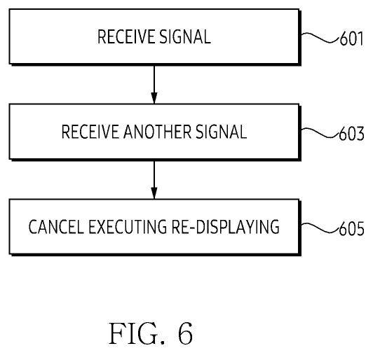

Referring back to FIG. 1, the display driver circuitry 120 may cancel executing the re-displaying, based on receiving another signal from the touch circuitry 150. For example, the other signal may be transmitted after the signal is transmitted from the touch circuitry 150. Cancelling executing the re-displaying in accordance with a reception of the other signal will be discussed with reference to FIG. 6.

FIG. 6 illustrates an example method of cancelling to execute a re-displaying, based on another signal from touch circuitry according to various embodiments.

Operation 601 of FIG. 6 may be related to operation 203 of FIG. 2, and operations 603 and 605 of FIG. 6 may be included within operation 205 of FIG. 2.

Referring to FIG. 6, in operation 601, the display driver circuitry 120 may receive the signal from the touch circuitry 150 through a second path 151 while the image is displayed or maintained on the display panel 140. Operation 601 may at least partially correspond to operation 203 of FIG. 2.

In operation 603, the display driver circuitry 120 may receive another signal from the touch circuitry 150 through the second path 152 within the reference time, after the signal is received. For example, the other signal, which is a signal received after the signal is received in operation 601, may indicate a release of the contact or indicate a movement of the contact.

In operation 605, the display driver circuitry 120 may cancel executing the re-displaying in response to the other signal received after the signal is received. For example, the other signal indicating the release of the contact may indicate that the contact causing the signal is relatively likely to be a touch input (e.g., a tap input), so the display driver circuitry 120 may cancel executing the re-displaying. For example, since the other signal indicating the movement of the contact indicates that the contact causing the signal is relatively likely to be a touch input (e.g., a drag input), the display driver circuitry 120 may cancel executing the re-displaying. For example, the display driver circuitry 120 may execute the display by discarding the image in the memory 130.

As described above, the electronic device 110 may refrain from the re-displaying by cancelling the re-displaying based on the signal and the other signal. The electronic device 100 may enhance the responsiveness of the touch input by refraining from the re-displaying.

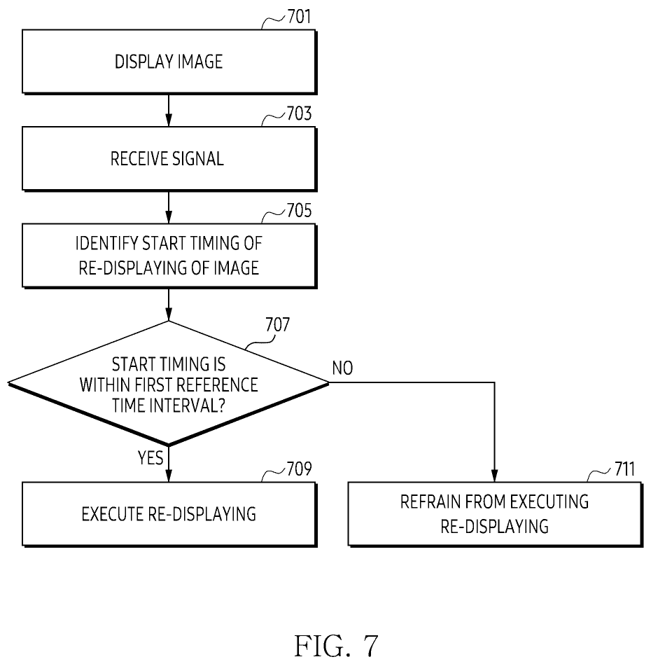

Referring back to FIG. 1, the display driver circuitry 120 may execute the re-displaying of the image, on a condition that the re-displaying of the image scheduled within the reference time interval is completed before a timing at which the other image may be received from the processor 110 in response to the contact. The re-displaying of the image executed on a condition that the re-displaying is completed before the timing will be discussed below with reference to FIG. 7.

FIG. 7 illustrates an example method of identifying whether to execute a re-displaying of an image, based on a signal from touch circuitry according to various embodiments.

Referring to FIG. 7, in operation 701, the display driver circuitry 120 may display an image on the display panel 140, based on a refresh rate lower than the reference refresh rate. Operation 701 may correspond to operation 201 of FIG. 2.

In operation 703, the display driver circuitry 120 may receive a signal, which is transmitted to the processor 110 through the first path 151, from the touch circuitry 150 through the second path 152, the signal indicating a contact on the image displayed on the display panel 140. Operation 703 may correspond to operation 203 of FIG. 2.

In operation 705, the display driver circuitry 120 may identify a start timing of the re-displaying of the image to be executed by scanning the image stored in the memory 130 based on the refresh rate in response to the signal. For example, the display driver circuitry 120 may identify the start timing of the re-displaying of the image scheduled when the signal is received at operation 703.

In operation 707, the display driver circuitry 120 may identify whether the start timing is within a first reference time interval from a reception timing of the signal. For example, the display driver circuitry 120 may identify whether the start timing is within the first reference time interval, in order to identify whether the re-displaying of the image may be completed within the first reference time interval. For example, the first reference time interval may be terminated before the timing at which another image may be received when the contact is a touch input. For example, the first reference time interval may be shorter than the reference time interval.

For example, the display driver circuitry 120 may execute operation 709 based on the start timing within the first reference time interval, and execute operation 711 based on the start timing being out of the first reference time interval.

In operation 709, the display driver circuitry 120 may execute the re-displaying from the start timing based on the start timing within the first reference time interval. For example, since the start timing being within the first reference time interval indicates that the re-displaying of the image is completed before a response (or feedback) in accordance with the contact is received from the processor 110, the display driver circuitry 120 may execute the re-displaying.

For example, referring to FIG. 3, the display driver circuitry 120 may execute the scan 305 based on identifying that the start timing is within a first reference time interval 383 from a reception timing 302. For example, the scan 305 may be executed at a start timing of one light-emitting interval from among light-emitting intervals 384 within the first reference time interval 383. However, it is not limited thereto.

Referring back to FIG. 7, in operation 711, the display driver circuitry 120 may refrain from executing the re-displaying, based on the start timing being out of the first reference time interval. For example, the display driver circuitry 120 may refrain from executing the re-displaying, based on the start timing being out of the first reference time interval and within the second reference time interval. For example, the second reference time interval may be from the end timing of the first reference time interval. For example, referring to FIG. 3, a second reference time interval 386 may indicate a time range from an end timing 385 of the first reference time interval 383 to a timing 306.

Referring again to FIG. 7, the display driver circuitry 120 may refrain from executing the re-displaying by changing a start timing of the re-displaying, based on the start timing being out of the first reference time interval. For example, in response to the signal, the display driver circuitry 120 may identify whether another image obtained in accordance with the contact is received from the processor 110 within a second reference time interval from an end timing of the first reference time interval. For example, in response to the other image received within the second reference time interval, the display driver circuitry 120 may display the other image on the display panel 140, and cancel executing the re-displaying. For example, in response to the other image not being received within the second reference time interval, the display driver circuitry 120 may execute the re-displaying from another start timing being out of the second reference time interval. For example, when the contact is a touch input, the other image may be transmitted from the processor 110 within the second reference time interval.

Although not illustrated in FIG. 7, the display driver circuitry 120 may refrain from executing the re-displaying from the start timing by cancelling executing the re-displaying, in response to receiving the other signal, transmitted to the processor 110 via the first path 151, from the touch circuitry 150 via the second path 152 within the first reference time interval or the second reference time interval, the other signal indicating a release of the contact.

Although not illustrated in FIG. 7, the display driver circuitry 120 may refrain from executing the re-displaying from the start timing by cancelling executing the re-displaying, in response to receiving another signal, transmitted to the processor 110 via the first path 151, from the touch circuitry 150 via the second path 152 within the first reference time interval or the second reference time interval, the other signal indicating a movement of the contact maintained on the image.

As described above, the electronic device 100 may enhance the responsiveness of the touch input by refraining from the re-displaying of the image within the reference time interval, based on the signal and/or the other signal received by the display driver circuitry 120 via the second path 152.

FIG. 8 is a block diagram illustrating an example electronic device 801 in a network environment 800 according to various embodiments. Referring to FIG. 8, the electronic device 801 in the network environment 800 may communicate with an electronic device 802 via a first network 898 (e.g., a short-range wireless communication network), or at least one of an electronic device 804 or a server 808 via a second network 899 (e.g., a long-range wireless communication network). According to an embodiment, the electronic device 801 may communicate with the electronic device 804 via the server 808. According to an embodiment, the electronic device 801 may include a processor 820, memory 830, an input module 850, a sound output module 855, a display module 860, an audio module 870, a sensor module 876, an interface 877, a connecting terminal 878, a haptic module 879, a camera module 880, a power management module 888, a battery 889, a communication module 890, a subscriber identification module (SIM) 896, or an antenna module 897. In various embodiments, at least one of the components (e.g., the connecting terminal 878) may be omitted from the electronic device 801, or one or more other components may be added in the electronic device 801. In various embodiments, some of the components (e.g., the sensor module 876, the camera module 880, or the antenna module 897) may be implemented as a single component (e.g., the display module 860).

The processor 820 (including, e.g., processing circuitry) may execute, for example, software (e.g., a program 840) to control at least one other component (e.g., a hardware or software component) of the electronic device 801 coupled with the processor 820, and may perform various data processing or computation. According to an embodiment, as at least part of the data processing or computation, the processor 820 may store a command or data received from another component (e.g., the sensor module 876 or the communication module 890) in volatile memory 832, process the command or the data stored in the volatile memory 832, and store resulting data in non-volatile memory 834. According to an embodiment, the processor 820 may include a main processor 821 (e.g., a central processing unit (CPU) or an application processor (AP)), or an auxiliary processor 823 (e.g., a graphics processing unit (GPU), a neural processing unit (NPU), an image signal processor (ISP), a sensor hub processor, or a communication processor (CP)) that is operable independently from, or in conjunction with, the main processor 821. For example, the various processors may operate individually or collectively to perform operations or functions. For example, when the electronic device 801 includes the main processor 821 and the auxiliary processor 823, the auxiliary processor 823 may be adapted to consume less power than the main processor 821, or to be specific to a specified function. The auxiliary processor 823 may be implemented as separate from, or as part of the main processor 821.

The auxiliary processor 823 may control at least some of functions or states related to at least one component (e.g., the display module 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). According to an embodiment, the auxiliary processor 823 (e.g., an image signal processor or a communication processor) may be implemented as part of another component (e.g., the camera module 880 or the communication module 890) functionally related to the auxiliary processor 823. According to an embodiment, the auxiliary processor 823 (e.g., the neural processing unit) may include a hardware structure specified for artificial intelligence model processing. An artificial intelligence model may be generated by machine learning. Such learning may be performed, e.g., by the electronic device 801 where the artificial intelligence is performed or via a separate server (e.g., the server 808). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but is not limited thereto. The artificial intelligence model may, additionally or alternatively, include a software structure other than the hardware structure.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input module 850 (including, e.g., input circuitry) may receive a command or data to be used by another component (e.g., the processor 820) of the electronic device 801, from the outside (e.g., a user) of the electronic device 801. The input module 850 may include, for example, a microphone, a mouse, a keyboard, a key (e.g., a button), or a digital pen (e.g., a stylus pen).

The sound output module 855 (including, e.g., sound output circuitry) may output sound signals to the outside of the electronic device 801. The sound output module 855 may include, for example, a speaker or a receiver. The speaker may be used for general purposes, such as playing multimedia or playing record. The receiver may be used for receiving incoming calls. According to an embodiment, the receiver may be implemented as separate from, or as part of, the speaker.

The display module 860 may visually provide information to the outside (e.g., a user) of the electronic device 801. The display module 860 may include, for example, a display, a hologram device, or a projector and control circuitry to control a corresponding one of the display, hologram device, and projector. According to an embodiment, the display module 860 may include a touch sensor adapted to detect a touch, or a pressure sensor adapted to measure the intensity of force incurred by the touch.

The audio module 870 (including, e.g., audio circuitry) may convert a sound into an electrical signal and vice versa. According to an embodiment, the audio module 870 may obtain the sound via the input module 850, or output the sound via the sound output module 855 or a headphone of an external electronic device (e.g., an electronic device 802) directly (e.g., wiredly) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. According to an embodiment, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 (including, e.g., interface circuitry) may support one or more specified protocols to be used for the electronic device 801 to be coupled with the external electronic device (e.g., the electronic device 802) directly (e.g., wiredly) or wirelessly. According to an embodiment, the interface 877 may include, for example, a high definition multimedia interface (HDMI), a universal serial bus (USB) interface, a secure digital (SD) card interface, or an audio interface.

A connecting terminal 878 may include a connector via which the electronic device 801 may be physically connected with the external electronic device (e.g., the electronic device 802). According to an embodiment, the connecting terminal 878 may include, for example, an HDMI connector, a USB connector, a SD card connector, or an audio connector (e.g., a headphone connector).

The haptic module 879 may convert an electrical signal into a mechanical stimulus (e.g., a vibration or a movement) or electrical stimulus which may be recognized by a user via tactile sensation or kinesthetic sensation. According to an embodiment, the haptic module 879 may include, for example, a motor, a piezoelectric element, or an electric stimulator.

The camera module 880 (including, e.g., a camera) may capture a still image or moving images. According to an embodiment, the camera module 880 may include one or more lenses, image sensors, image signal processors, or flashes.

The power management module 888 may manage power supplied to the electronic device 801. According to an embodiment, the power management module 888 may be implemented as at least part of, for example, a power management integrated circuit (PMIC).

The battery 889 may supply power to at least one component of the electronic device 801. According to an embodiment, the battery 889 may include, for example, a primary cell which is not rechargeable, a secondary cell which is rechargeable, or a fuel cell.

The communication module 890 (including, e.g., communication circuitry) may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor (AP)) and supports a direct (e.g., wired) communication or a wireless communication. According to an embodiment, the communication module 890 may include a wireless communication module 892 (including, e.g., wireless communication circuitry) (e.g., a cellular communication module, a short-range wireless communication module, or a global navigation satellite system (GNSS) communication module) or a wired communication module 894 (including, e.g., wired communication circuitry) (e.g., a local area network (LAN) communication module or a power line communication (PLC) module). A corresponding one of these communication modules may communicate with the external electronic device via the first network 898 (e.g., a short-range communication network, such as Bluetooth™, wireless-fidelity (Wi-Fi) direct, or infrared data association (IrDA)) or the second network 899 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The wireless communication module 892 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., the mmWave band) to achieve, e.g., a high data transmission rate. The wireless communication module 892 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 892 may support various requirements specified in the electronic device 801, an external electronic device (e.g., the electronic device 804), or a network system (e.g., the second network 899). According to an embodiment, the wireless communication module 892 may support a peak data rate (e.g., 20 Gbps or more) for implementing eMBB, loss coverage (e.g., 864 dB or less) for implementing mMTC, or U-plane latency (e.g., 0.5 ms or less for each of downlink (DL) and uplink (UL), or a round trip of 8 ms or less) for implementing URLLC.

The antenna module 897 may transmit or receive a signal or power to or from the outside (e.g., the external electronic device) of the electronic device 801. According to an embodiment, the antenna module 897 may include an antenna including a radiating element including a conductive material or a conductive pattern formed in or on a substrate (e.g., a printed circuit board (PCB)). According to an embodiment, the antenna module 897 may include a plurality of antennas (e.g., array antennas). In such a case, at least one antenna appropriate for a communication scheme used in the communication network, such as the first network 898 or the second network 899, may be selected, for example, by the communication module 890 (e.g., the wireless communication module 892) from the plurality of antennas. The signal or the power may then be transmitted or received between the communication module 890 and the external electronic device via the selected at least one antenna. According to an embodiment, another component (e.g., a radio frequency integrated circuit (RFIC)) other than the radiating element may be additionally formed as part of the antenna module 897.

According to various embodiments, the antenna module 897 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 801 and the external electronic device 804 via the server 808 coupled with the second network 899. Each of the electronic devices 802 or 804 may be a device of a same type as, or a different type, from the electronic device 801. According to an embodiment, all or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 801. The electronic device 801 may provide the outcome, with or without further processing of the outcome, as at least part of a reply to the request. To that end, a cloud computing, distributed computing, mobile edge computing (MEC), or client-server computing technology may be used, for example. The electronic device 801 may provide ultra low-latency services using, e.g., distributed computing or mobile edge computing. In an embodiment, the external electronic device 804 may include an internet-of-things (IoT) device. The server 808 may be an intelligent server using machine learning and/or a neural network. According to an embodiment, the external electronic device 804 or the server 808 may be included in the second network 899. The electronic device 801 may be applied to intelligent services (e.g., smart home, smart city, smart car, or healthcare) based on 5G communication technology or IoT-related technology.

FIG. 9 is a block diagram illustrating an example display module 860 according to various embodiments. Referring to FIG. 9, the display module 860 may include a display 910 and a display driver integrated circuit (DDI) 930 to control the display 910. The DDI 930 may include an interface module 931 (including, e.g., interface circuitry), memory 933 (e.g., buffer memory), an image processing module 935 (including, e.g., an image processor including image processing cicuitry), or a mapping module 937. The DDI 930 may receive image information that contains image data or an image control signal corresponding to a command to control the image data from another component of the electronic device 801 via the interface module 931. For example, according to an embodiment, the image information may be received from the processor 820 (e.g., the main processor 821 (e.g., an application processor)) or the auxiliary processor 823 (e.g., a graphics processing unit) operated independently from the function of the main processor 821. The DDI 930 may communicate, for example, with touch circuitry 950 or the sensor module 876 via the interface module 931. The DDI 930 may also store at least part of the received image information in the memory 933, for example, on a frame by frame basis. The image processing module 935 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 910. The mapping module 937 may generate a voltage value or a current value corresponding to the image data pre-processed or post-processed by the image processing module 935. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 910 may be driven, for example, based at least in part on the voltage value or the current value such that visual information (e.g., a text, an image, or an icon) corresponding to the image data may be displayed via the display 910.

According to an embodiment, the display module 860 may further include the touch circuitry 950. The touch circuitry 950 may include a touch sensor 951 and a touch sensor IC 953 to control the touch sensor 951. The touch sensor IC 953 may control the touch sensor 951 to sense a touch input or a hovering input with respect to a certain position on the display 910. To achieve this, for example, the touch sensor 951 may detect (e.g., measure) a change in a signal (e.g., a voltage, a quantity of light, a resistance, or a quantity of one or more electric charges) corresponding to the certain position on the display 910. The touch circuitry 950 may provide input information (e.g., a position, an area, a pressure, or a time) indicative of the touch input or the hovering input detected via the touch sensor 951 to the processor 820. According to an embodiment, at least part (e.g., the touch sensor IC 953) of the touch circuitry 950 may be formed as part of the display 910 or the DDI 930, or as part of another component (e.g., the auxiliary processor 823) disposed outside the display module 860.

According to an embodiment, the display module 860 may further include at least one sensor (e.g., a fingerprint sensor, an iris sensor, a pressure sensor, or an illuminance sensor) of the sensor module 876 or a control circuit for the at least one sensor. In such a case, the at least one sensor or the control circuit for the at least one sensor may be embedded in one portion of a component (e.g., the display 910, the DDI 930, or the touch circuitry 950)) of the display module 860. For example, when the sensor module 876 embedded in the display module 860 includes a biometric sensor (e.g., a fingerprint sensor), the biometric sensor may obtain biometric information (e.g., a fingerprint image) corresponding to a touch input received via a portion of the display 910. As another example, when the sensor module 876 embedded in the display module 860 includes a pressure sensor, the pressure sensor may obtain pressure information corresponding to a touch input received via a partial or whole area of the display 910. According to an embodiment, the touch sensor 951 or the sensor module 876 may be disposed between pixels in a pixel layer of the display 910, or over or under the pixel layer.

According to an example embodiment, an electronic device 100 may comprise at least one processor 110, touch circuitry 150, a display panel 140, display driver circuitry 120 including memory 130, a first path 151 connecting the processor 110 to the touch circuitry 150, and a second path 152 connecting the display driver circuitry 120 to the touch circuitry 150. According to an example embodiment, the display driver circuitry 120 may be configured to, based on a refresh rate lower than a reference refresh rate, display, via the display panel 140, an image; receive, through the second path 152, from the touch circuitry 150, a signal transmitted through the first path 151 to the processor 110, the signal indicating a contact on the image displayed on the display panel 140; and, in response to the signal, refrain from, within a reference time interval from a reception timing of the signal, a re-displaying of the image executed by scanning the image stored in the memory 130 based on the refresh rate.

According to an example embodiment, the display driver circuitry 120 may be configured to refrain from executing the re-displaying by deferring the re-displaying of the image being within the reference time interval.

According to an example embodiment, the display driver circuitry 120 may be configured to, in response to the signal, identify whether another image obtained in accordance with the contact is received from the processor 110 within the reference time interval. According to example an embodiment, the display driver circuitry 120 may be configured to, in response to the other image being received within the reference time interval, display, on the display panel 140, the other image, and cancel executing the re-displaying. According to an example embodiment, the display driver circuitry 120 may be configured to, in response to the other image not being received within the reference time interval, execute the re-displaying from another start timing which is out of the reference time interval.

According to an example embodiment, the processor 110 may be configured to receive, through the first path 151, from the touch circuitry 150, the signal; receive data, transmitted through the first path 151 from the touch circuitry 150 after the signal is transmitted, indicating an area on which the contact is located; based on the signal and the data, obtain the other image; and transmit, to the display driver circuitry 120, the other image within the reference time interval.

According to an example embodiment, the display driver circuitry 120 may be configured to receive the signal from among the data and the signal.

According to an example embodiment, the display driver circuitry 120 may be configured to receive, through the second path 152, from the touch circuitry 150, within the reference time interval, another signal, transmitted through the first path 151 to the processor 110, indicating a release of the contact and, in response to the other signal, refrain from executing the re-displaying by cancelling to execute the re-displaying.

According to an example embodiment, the display driver circuitry 120 may be configured to receive, through the second path 152, from the touch circuitry 150, within the reference time interval, another signal, transmitted through the first path 151 to the processor 110, indicating a movement of the contact maintained on the image and, in response to the other signal, refrain from executing the re-displaying by cancelling to execute the re-displaying.

According to an example embodiment, the display driver circuitry 120 may be configured to, based on a control command, obtained from the processor 110 based on the refresh rate before the image is received from the processor 110, store the image in the memory 130.

According to an example embodiment, the display driver circuitry 120 may be configured to, in response to the signal, change a state of an indication signal, provided from the display driver circuitry 120 to the processor 110, indicating whether an image transmission from the processor 110 to the display driver circuitry 120 is enabled, from a second state to a first state, wherein the first state indicates enabling the image transmission, and wherein the second state indicates disabling the image transmission.

According to an example embodiment, the memory 130 may be disabled based at least in part on another refresh rate higher than or equal to the reference refresh rate and may be enabled based on the refresh rate lower than the reference refresh rate.

In an example embodiment, an electronic device 100 may include at least one processor 110, touch circuitry 150, a display panel 140, display driver circuitry 120 including memory 130, a first path 151 connecting the processor 110 to the touch circuitry 150, and a second path 152 connecting the display driver circuitry 120 to the touch circuitry 150. According to an example embodiment, the display driver circuitry 120 may be configured to, based on a refresh rate lower than a reference refresh rate, display, via the display panel 140, an image; receive, through the second path 152, from the touch circuitry 150, a signal transmitted through the first path 151 to the processor 110, the signal indicating a contact on the image displayed on the display panel 140; in response to the signal, identify a start timing of re-displaying of the image to be executed by scanning the image stored in the memory 130 based on the refresh rate; execute the re-displaying from the start timing, based on the start timing being within a reference time interval from a reception timing of the signal; and refrain from executing the re-displaying, based on the start timing being out of the reference time interval.

According to an example embodiment, the display driver circuitry 120 may be configured to refrain from executing the re-displaying by changing a start timing of the re-displaying, based on the start timing being out of the reference time interval.

According to an example embodiment, the display driver circuitry 120 may be configured to identify, in response to the signal, whether another image obtained in accordance with the contact is received from the processor 110 within another reference time interval from an end timing of the reference time interval; in response to the other image being received within the other reference time interval, display the other image on the display panel 140 and cancel executing the re-displaying; and, in response to the other image not being received within the other reference time interval, execute the re-displaying from another start timing being out of the other reference time interval.

According to an example embodiment, the processor 110 may be configured to receive, through the first path 151, from the touch circuitry 150, the signal; receive data, transmitted through the first path 151 from the touch circuitry 150 after the signal is transmitted, indicating an area on which the contact is located; based on the signal and the data, obtain the other image; and transmit, to the display driver circuitry 120, the other image within the reference time interval.

According to an example embodiment, the display driver circuitry 120 may be configured to receive the signal from among the data and the signal.

According to an example embodiment, the display driver circuitry 120 may be configured to receive, through the second path 152, from the touch circuitry 150, within the reference time interval or another reference time interval from an end timing of the reference time interval, another signal, transmitted through the first path 151 to the processor 110, indicating a release of the contact and, in response to the other signal, refrain from executing the re-displaying by cancelling to execute the re-displaying.

According to an example embodiment, the display driver circuitry 120 may be configured to receive, through the second path 152, from the touch circuitry 150, within the reference time interval or another reference time interval from an end timing of the reference time interval, another signal, transmitted through the first path 151 to the processor 110, indicating a movement of the contact maintained on the image and, in response to the other signal, refrain from executing the re-displaying by cancelling to execute the re-displaying.

According to an example embodiment, the display driver circuitry 120 may be configured to, based on a control command, obtained from the processor 110 based on the refresh rate before the image is received from the processor 110, store the image in the memory 130.

According to an example embodiment, the display driver circuitry 120 may be configured to, based on the start timing being out of the reference time interval, change a state of an indication signal, provided from the display driver circuitry 120 to the processor 110, indicating whether an image transmission from the processor 110 to the display driver circuitry 120 is enabled from a second state to a first state, wherein the first state indicates enabling the image transmission, and wherein the second state indicates disabling the image transmission.

According to an example embodiment, the memory 130 may be disabled based at least in part on another refresh rate higher than or equal to the reference refresh rate and may be enabled based on the refresh rate lower than the reference refresh rate.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” “at least one of A, B, or C,” and “at least one of A, B, and/or C” may include any one of or all possible combinations of the items enumerated together in a corresponding one of the phrases. As used herein, such terms as “1st” and “2nd,” or “first” and “second” may be used to simply distinguish a corresponding component from another, and do not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, and any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 840) including one or more instructions that are stored in a storage medium (e.g., internal memory 836 or external memory 838) that is readable by a machine (e.g., the electronic device 801). For example, a processor (e.g., the processor 820) of the machine (e.g., the electronic device 801) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium, where the term “non-transitory” simply refers to the storage medium being a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The disclosure has been described with reference to the embodiments. It would be appreciated by those skilled in the art that changes may be made to these embodiments without departing from the principles and spirit of the disclosure. Therefore, the disclosed embodiments are provided for the purpose of describing the disclosure and the disclosure should not be construed as being limited to only the embodiments set forth herein. The scope of the disclosure is defined by the claims as opposed to by the above-mentioned descriptions, and it should be understood that disclosure includes all differences made within the equivalent scope. It will also be understood that any of the embodiment(s) described herein may be used in conjunction with any other embodiment(s) described herein.

What is claimed is:

1. An electronic device comprising:
at least one processor comprising processing circuitry;
touch circuitry;
a display panel;
display driver circuitry including memory;
a first path connecting the at least one processor to the touch circuitry; and
a second path connecting the display driver circuitry to the touch circuitry,
wherein the display driver circuitry is configured to:
based on a refresh rate lower than a reference refresh rate, display, via the display panel, an image;
receive, through the second path, from the touch circuitry, a signal transmitted through the first path to the at least one processor, the signal indicating a contact on the image displayed on the display panel; and
in response to the signal, refrain from, within a reference time interval from a reception timing of the signal, a re-displaying of the image executed by scanning the image stored in the memory based on the refresh rate.

2. The electronic device of claim 1, wherein the display driver circuitry is configured to refrain from executing the re-displaying by deferring the re-displaying of the image from being within the reference time interval.

3. The electronic device of claim 2, wherein the display driver circuitry is configured to:
in response to the signal, identify whether another image obtained in accordance with the contact is received within the reference time interval from the at least one processor;
in response to the other image being received within the reference time interval, display, on the display panel, the other image, and cancel executing of the re-displaying; and
in response to the other image not being received within the reference time interval, execute the re-displaying from another start timing which is out of the reference time interval.

4. The electronic device of claim 3, further comprising:
memory comprising one or more storage media storing instructions,
wherein the instructions, when executed by the at least one processor individually or collectively, cause the electronic device to:
receive, through the first path, from the touch circuitry, the signal;
receive data, transmitted through the first path from the touch circuitry after the signal is transmitted, indicating an area on which the contact is located;
based on the signal and the data, obtain the other image; and
transmit, to the display driver circuitry, the other image within the reference time interval.

5. The electronic device of claim 4, wherein the display driver circuitry is configured to receive the signal from among the data and the signal.

6. The electronic device of claim 1, wherein the display driver circuitry is further configured to:
receive, through the second path, from the touch circuitry, within the reference time interval, another signal, transmitted through the first path to the at least one processor, indicating a release of the contact; and
in response to the other signal, refrain from executing the re-displaying by cancelling to execute the re-displaying.

7. The electronic device of claim 1, wherein the display driver circuitry is further configured to:
receive, through the second path, from the touch circuitry, within the reference time interval, another signal, transmitted through the first path to the at least one processor, indicating a movement of the contact maintained on the image; and
in response to the other signal, refrain from executing the re-displaying by cancelling to execute the re-displaying.

8. The electronic device of claim 1, wherein the display driver circuitry is further configured to:
based on a control command, obtained from the at least one processor based on the refresh rate before the image is received from the at least one processor, store the image in the memory.

9. The electronic device of claim 1, wherein the display driver circuitry is further configured to:
in response to the signal, change a state of an indication signal, provided from the display driver circuitry to the at least one processor, indicating whether an image transmission from the at least one processor to the display driver circuitry is enabled from a second state to a first state,
wherein the first state indicates enabling the image transmission, and
wherein the second state indicates disabling the image transmission.

10. The electronic device of claim 1, wherein:
based at least in part on another refresh rate higher than or equal to the reference refresh rate, the memory is disabled; and
based on the refresh rate lower than the reference refresh rate, the memory is enabled.

11. An electronic device comprising:
at least one processor comprising processing circuitry;
touch circuitry;
a display panel;
display driver circuitry including memory;
a first path connecting the at least one processor to the touch circuitry; and
a second path connecting the display driver circuitry to the touch circuitry,
wherein the display driver circuitry is configured to:
based on a refresh rate lower than a reference refresh rate, display, on the display panel, an image;
receive, through the second path, from the touch circuitry, a signal transmitted through the first path to the at least one processor, the signal indicating a contact on the image displayed on the display panel;
in response to the signal, identify a start timing of a re-displaying of the image to be executed by scanning the image stored in the memory based on the refresh rate;
based on the start timing being within a reference time interval from a reception timing of the signal, execute the re-displaying from the start timing; and
based on the start timing being out of the reference time interval, refrain from executing the re-displaying.

12. The electronic device of claim 11, wherein the display driver circuitry is configured to:
based on the start timing being out of the reference time interval, refrain from executing the re-displaying by adjusting a start timing of the re-displaying.

13. The electronic device of claim 12, wherein the display driver circuitry is configured to:
in response to the signal, identify whether another image obtained in accordance with the contact is received from the at least one processor within another reference time interval from an end timing of the reference time interval;
in response to the another image being received within the another reference time interval, display, on the display panel, the another image, and cancel executing the re-displaying; and
in response to the another image not being received within the another reference time interval, executing the re-displaying from another start timing being out of the another reference time interval.

14. The electronic device of claim 11, further comprising:
memory comprising one or more storage media storing one or more programs configured to be executed by the at least one processor individually or collectively,
wherein the one or more programs include instructions that cause the electronic device to:
receive, from the touch circuitry, via the first path, the signal;
receive data, transmitted via the first path from the touch circuitry after the signal is transmitted, indicating an area on which the contact is located;
based on the signal and the data, obtain the another image; and
transmit the another image to the display driver circuitry within the another reference time interval.

15. The electronic device of claim 14, wherein the display driver circuitry is configured to:
receive the signal from among the signal and the data.

16. The electronic device of claim 11, wherein the display driver circuitry is further configured to:
receive, via the second path, from the touch circuitry, another signal within the reference tine interval or within another reference time interval from an end timing of the reference time interval, the another signal, transmitted via the first path to the at least one processor, indicating a release of the contact; and
in response to the another signal, refrain from executing the re-displaying from the start timing by cancelling executing the re-displaying.

17. The electronic device of claim 11, wherein the display driver circuitry is further configured to:
receive, via the second path, from the touch circuitry, another signal within the reference time interval or within another reference time interval from an end timing of the reference time interval, the another signal, indicating a movement of the contact maintained on the image, transmitted via the first path to the at least one processor; and
in response to the another signal, refrain from executing the re-displaying from the start timing by cancelling executing the re-displaying.

18. The electronic device of claim 11, wherein the display driver circuitry is further configured to:
based on a control command, obtained from the at least one processor based on the refresh rate before the image is received from the at least one processor, indicating to enable the memory, store the image in the memory.

19. The electronic device of claim 11, wherein the display driver circuitry is further configured to:
based on the start timing being out of the reference time interval, change a state of an indication signal, provided from the display driver circuitry to the at least one processor, indicating whether the image transmission from the at least one processor to the display driver circuitry, from the second state indicating disabling the image transmission to the first state indicating enabling the image transmission.

20. The electronic device of claim 11, wherein:
based at least in part on another refresh rate higher than the reference refresh rate, the memory is disabled; and
based on the refresh rate lower than the reference refresh rate, the memory is enabled.
